(19) United States
(12) Patent Application Publication
(10) Pub. No.: US 2011/0287811 A1
(43) Pub. Date: Nov. 24, 2011

(54) METHOD AND APPARATUS FOR AN AUGMENTED REALITY X-RAY

(75) Inventors: Ville-Veikko Mattila, Tampere (FI); Andrew Cunningham, Parkside (AU); Christian Sandor, Adelaide (AU)

(73) Assignee: Nokia Corporation, Espoo (FI)

(21) Appl. No.: 12/785,170

(22) Filed: May 21, 2010

(51) Int. Cl. H04B 1/38; G06K 9/48; G06K 9/46

(52) U.S. Cl. 455/566; 382/190; 382/199

(57) ABSTRACT

An approach is provided for generating an augmented reality X-Ray composite image. A visual saliency is determined of one or more features of a first image, a second image, or a combination thereof. The one or more features of the first image occlude, at least in part, one or more features of the second image. The first image and the second image are composited based, at least in part, on the visual saliency.

### BACKGROUND

Service providers and device manufacturers (e.g., wireless, cellular, etc.) are continually challenged to deliver value and convenience to consumers by, for example, providing compelling network services. These network services can include one or more options for navigation, mapping, or augmented reality. One approach to augmented reality is to provide a superhero-like X-Ray viewing capability on a device. By way of example, this type of augmented reality X-Ray viewing capability is a pseudo-X-Ray that can show previously taken or concurrent images behind one or more occluding objects. However, providing augmented reality X-Ray capabilities to devices present many technical issues. For example, when providing an augmented reality X-Ray image on a two dimensional screen, depth perception can be lost and can become difficult for a user to determine what part of the image is part of the augmented reality X-Ray and what part of the image is part of the pseudo-X-Rayed section. This lack of depth perception can affect the usability of the service to a user. A poor user impression can be detrimental to the user further utilizing services from the service provider and/or device manufacturer.

### SOME EXAMPLE EMBODIMENTS

Therefore, there is a need for an approach for generating an augmented reality X-Ray composite image.

According to one embodiment, a method comprises determining a visual saliency of one or more features of a first image, a second image, or a combination thereof. The one or more features of the first image occlude, at least in part, one or more features of the second image. The method also comprises causing, at least in part, compositing of the first image and the second image based, at least in part, on the visual saliency.

According to another embodiment, an apparatus comprising at least one processor, and at least one memory including computer program code, the at least one memory and the computer program code configured to, with the at least one processor, cause, at least in part, the apparatus to determine a visual saliency of one or more features of a first image, a second image, or a combination thereof. The one or more features of the first image occlude, at least in part, one or more features of the second image. The apparatus is also causes, at least in part, compositing of the first image and the second image based, at least in part, on the visual saliency.

According to another embodiment, a computer-readable storage medium carrying one or more sequences of one or more instructions which, when executed by one or more processors, cause, at least in part, an apparatus to determine a visual saliency of one or more features of a first image, a second image, or a combination thereof. The one or more features of the first image occlude, at least in part, one or more features of the second image. The apparatus also causes, at least in part, compositing of the first image and the second image based, at least in part, on the visual saliency.

According to another embodiment, an apparatus comprises means for determining a visual saliency of one or more features of a first image, a second image, or a combination thereof. The one or more features of the first image occlude, at least in part, one or more features of the second image. The apparatus also comprises means for causing, at least in part, compositing of the first image and the second image based, at least in part, on the visual saliency.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing augmented reality X-Ray images to users, according to one embodiment;

FIG. 2 is a diagram of the components of user equipment to provide augmented reality X-Ray images to users, according to one embodiment;

FIG. 3A is a diagram showing a map showing an orientation of a UE 101 compared to images stored in a database, according to one embodiment;

FIGS. 3B-3E are diagrams showing user interfaces to view an augmented reality application, according to various embodiments;

FIG. 4 is a flowchart of a process for providing augmented reality X-Ray images to users, according to one embodiment;

FIG. 5 is a diagram showing different types of saliency maps that can be created based on an input image, according to one embodiment;

FIG. 6 is a diagram depicting composition of two images to generate an augmented reality X-Ray composite image, according to one embodiment;

FIG. 7 is a diagram of a process for compositing images to generate an augmented reality X-Ray composite image, according to one embodiment

FIGS. 8A and 8B are diagrams of user interfaces showing augmented reality X-Ray images, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for generating and presenting an augmented reality (AR) X-Ray image to users are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

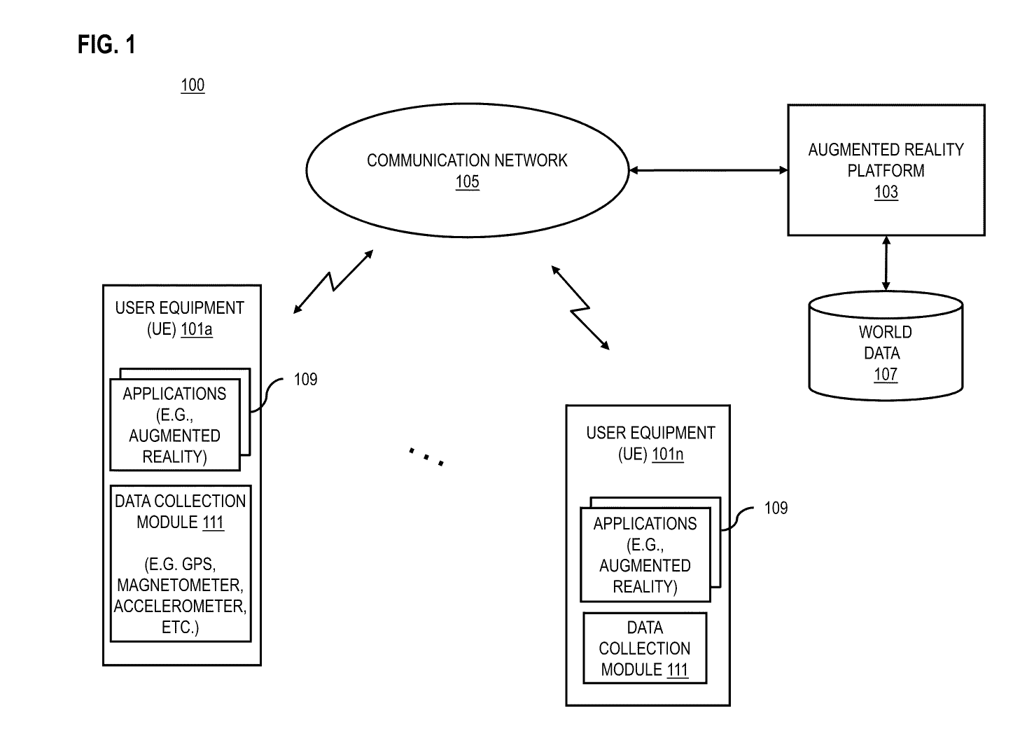

FIG. 1 is a diagram of a system capable of providing augmented reality X-Ray images to users, according to one embodiment. Mobile devices are becoming ubiquitous in the world today and with these mobile devices, many services are being provided. These services can include AR services and applications. AR allows a user's view of the real world to be overlaid with additional visual information. In an AR X-Ray application, one or more occluded images or points-of-interest (POIs) can be presented through an occluder image with one or more occluding objects. That is a pseudo-X-Ray or a virtual X-Ray can be used to show one or more objects on the other side of the occluding object on the occluder image. In one embodiment, an occluder image is an image that blocks or gets in the way of one or more parts of another image. In another embodiment, an occluded image is an image that is blocked by one or more parts of an occluder image. The AR X-Ray can show parts of the occluded image as a virtual X-Ray of the occluder image.

Users of devices can benefit from viewing occluded areas. For example, users can choose to utilize such features in pedestrian navigation tasks. AR X-Ray can show portions of the occluded image through portions of the occluder image. The portions may be based on defined shapes (e.g., an oval, a cloud, a rectangle, a square, a triangle, etc.) or may be unbounded. Rendering the occluded area naively over the real world image can cause the occluded region to appear to float in front of the real world and thus lose context with respect to the occluder image. A difficulty to in rendering arises from this loss of context between visible portions of the occluder image and the occluded image. These rendering difficulties can be overcome to improve the cognition of the occluded region and the occluder region.

To address this problem, a system 100 of FIG. 1 introduces the capability to generate and present an AR X-Ray image based on salient features of one or more the images. In one embodiment, a real world image and another image of an object not visible in the real world image can be used to provide a composite AR X-Ray image that can be presented to the user. A visual saliency of one or more features of the real world image and one or more features of the other image can be determined. As used herein, visual saliency is a measure of the visual importance of one or more characteristics of the image or features of the image. For example, the visual importance may then be used to indicate landmark features or other features that give context and visual meaning to an image. The saliency is then used for compositing a composite AR X-Ray image. In one embodiment, the salient regions of the real world image are made opaque in the composite image while non-salient regions are made transparent to provide depth cues to help depth perception of a user. In this way, salient features of both the occluded and occluder images are preserved while non-salient features are made transparent or otherwise de-emphasized. In certain embodiments, visual saliency is a perceptual quality that makes the features stand out from other portions of the image. Different criteria can be used to determine the quality, such as color hue, shapes, color intensity, luminosity, motion, intensity, density, contrast, line orientation, line width, closure, lighting direction, size, curvature, three-dimensional depth cues, etc. For example, a red ball in a field of green grass may stand out based on color hue or a motorcycle in a field of cars may stand out.

User equipment (UEs) 101a-101n can be used to generate and present AR X-Ray images to users. In certain embodiments, the processing of the images may occur on the UE 101, in other embodiments, some or all of the processing may occur on one or more augmented reality platforms 103. The UE 101 and the augmented reality platform 103 can communicate via a communication network 105. In certain embodiments, the augmented reality platform 103 may additionally include world data 107 that can include media (e.g., video, audio, images, etc.) associated with particular locations (e.g., location coordinates in metadata). This world data 107 can include media from one or more users of UEs 101 and/or commercial users generating the content. In one example, commercial users can generate panoramic images of area by following specific paths or streets. These panoramic images may additionally be stitched together to generate a seamless image.

The user may use an application 109 (e.g., an augmented reality application) on the UE 101 to provide AR X-Ray imaging features to the user. In this manner, the user may activate the AR application 109. The AR application 109 can utilize a data collection module 111 to provide location and/or orientation of the UE 101. Further, the data collection module 111 may include an image capture module, which may include a digital camera or other means for generating real world images. These images can include one or more objects (e.g., a building, tree, sign, car, truck, etc.). The objects may block other objects, such as POIs, from being viewed. To view these objects, the user may utilize an AR X-Ray imaging feature. The AR application 109 can use the location of the UE 101 and orientation of the UE 101 to determine the location of the blocked or occluded object(s). A parameter in determining the location of the occluded object may include a distance parameter (e.g., based on a zoom function). The location of the blocked or occluded object can then be sent in a request to the augmented reality platform 103 to receive an image of the occluded object.

The augmented reality platform 103 receives the request for an image of the occluded object. The request may include a location of the UE 101, an orientation (e.g., a compass direction) of the UE 101, and a distance the user wishes to view an AR X-Ray image from the user's position. Further, in certain embodiments, the distance may be replaced with another parameter (e.g., one or more layers of object images from the location of the UE 101) to select the image of the occluded object. The augmented reality platform 103 then uses this information to search the world data 107 for the image of the occluded object. The image is then returned to the AR application 109 of the UE 101.

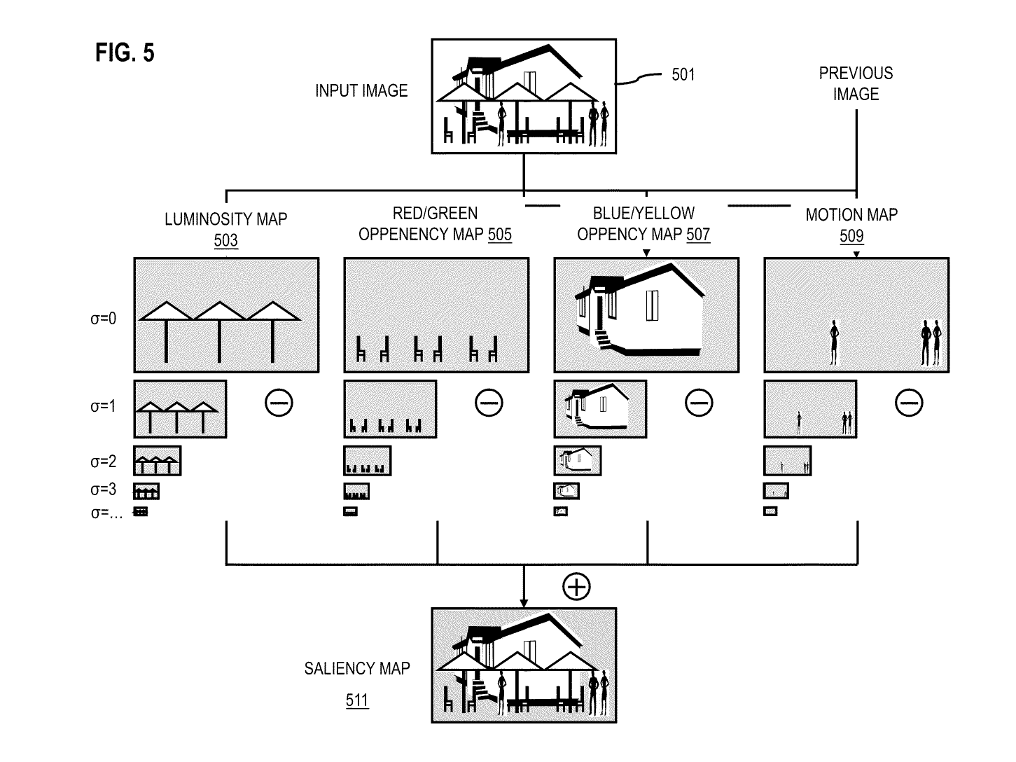

Then, the AR application 109 receives the occluded image of the occluded object from the augmented reality platform 103. Next, the AR application 109 can process the image of the real world image, or occluder image and the occluded image to generate a composite AR X-Ray image of the occluder image showing portions of the occluded image. The processing can include determining the salient features of each of the images using one or more saliency maps as further detailed in FIG. 5.

Once the salient features are determined, the AR application 109 can determine one or more locations of salient features in the occluder image. The AR application 109 can then compare the locations of salient features of the occluder image to the corresponding salient features of the occluded image. Once salient features are determined, the AR application 109 can select which salient features of each image to preserve for presentation based on criteria. In this scenario, preserving the respective one or more features can include rendering of the respective one or more features as opaque. Further, not preserving the respective one or more features can include causing rendering of the respective one or more features as transparent or substantially transparent. The one or more criteria can include a criterion that salient features of an occluder image are preserved during an overlap with salient features of the occluded image. In this manner, the user can advantageously perceive depth between the occluder and occluded images.

The selection of the salient features to present can be part of a compositing process to generate a composite AR X-Ray image to present to a user. Moreover, this AR X-Ray image can be caused to be presented to the user via a user interface of the UE 101. Additionally or alternatively, the user can change orientation of the UE 101 to update the occluder and occluded images and/or cause a zooming in or out of the occluder image to view different occluded images. Moreover, multiple images may be processed in this manner, wherein a first image occludes a second (or other middle images) and third image, and the second image occludes the third image. Similar processes can be utilized to preserve depth perception between the images.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, head-up display (HUD), augmented reality glasses, projectors, or any combination thereof, including the accessories and peripherals of these devices, or any combination thereof. It is also contemplated that the UE 101 can support any type of interface to the user (such as “wearable” circuitry, near-eye displays, head mounted circuitry, etc.).

By way of example, the UE 101 and augmented reality platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the augmented reality platform 103 may interact according to a client-server model with the applications 109 of the UE 101. According to the client-server model, a client process sends a message including a request to a server process, and the server process responds by providing a service (e.g., augmented reality image processing, augmented reality image retrieval, messaging, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

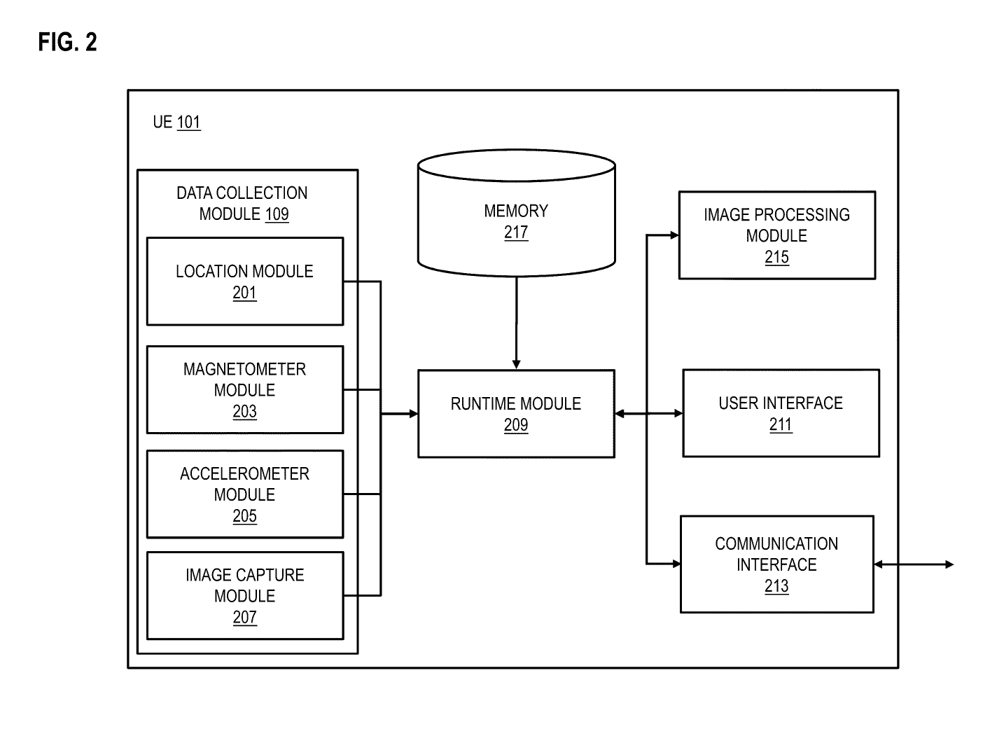

FIG. 2 is a diagram of the components of user equipment to provide augmented reality X-ray images to users, according to one embodiment. By way of example, a user equipment 101 includes one or more components for providing AR X-Ray image compositing. It is contemplated that the functions of these components may be combined in one or more components or performed by other components of equivalent functionality. In this embodiment, the UE 101 includes a data collection module 111 that may include one or more location modules 201, magnetometer modules 203, accelerometer modules 205, image capture modules 207, the UE 101 can also include a runtime module 209 to coordinate use of other components of the UE 101, a user interface 211, a communication interface 213, an image processing module 215, and memory 217.

The location module 201 can determine a user's location. The user's location can be determined by a triangulation system such as global positioning system (GPS), A-GPS, Cell of Origin, or other location extrapolation technologies. Standard GPS and A-GPS systems can use satellites to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are embedded into metadata of captured media (e.g., images, video, etc.) or otherwise associated with the UE 101 by the AR application 109. Moreover, in certain embodiments, the GPS coordinates can include an altitude to provide a height. In certain embodiments, the location module 201 can be a means for determining a location of the UE 101 or an image.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer is embedded into the metadata of captured or streaming media or otherwise associated with the UE 101 (e.g., by including the information in a request to an augmented reality platform 103) by the AR application 109.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module can determine the angle the UE 101 is pointed as compared to Earth's gravity. In one embodiment, vertical directional data obtained from an accelerometer is embedded into the metadata of captured or streaming media or otherwise associated with the UE 101 by the AR application 109.

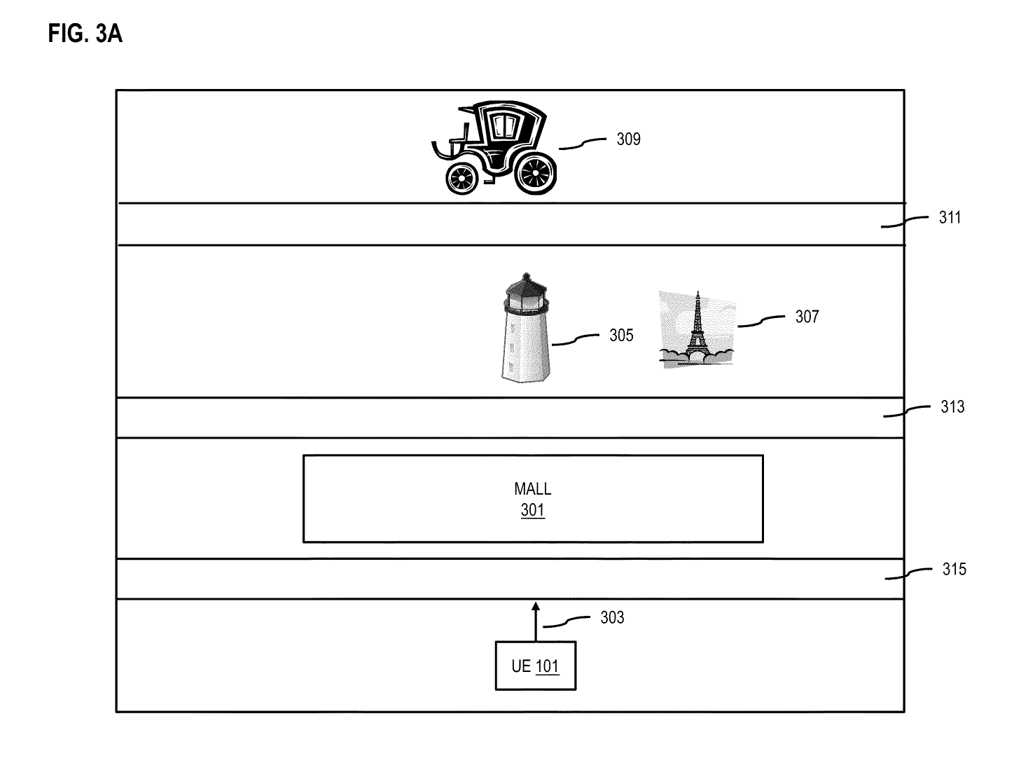

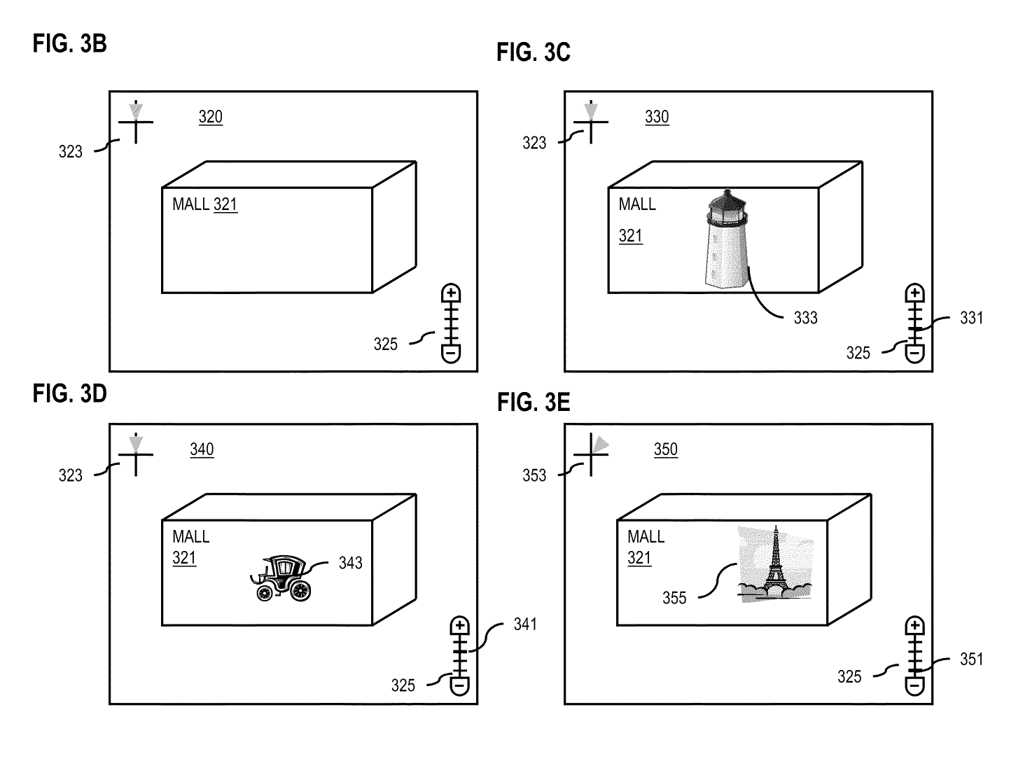

In one embodiment, the communication interface 213 can be used to communicate with an augmented reality platform 103 or other UEs 101. Certain communications can be via methods such as an internet protocol, messaging (e.g., SMS, MMS, etc.), or any other communication method (e.g., via the communication network 105). In some examples, the UE 101 can send a request to the augmented reality platform 103 via the communication interface 213. The augmented reality platform 103 may then send a response back via the communication interface 213. In certain embodiments, location and/or orientation information is used to generate a request to the augmented reality platform 103 for one or more images of one or more objects. Further, one or more selection parameters may be included in the request to determine which image to retrieve. Selection parameters may include a distance (e.g., based on a zoom function of the AR application 109), a level parameter, etc. A level parameter may be utilized in determining the image based on the location and orientation of the UE 101 as further detailed in FIG. 3A. The world data 107 can be stored as a database (e.g., a table) including one or more images associated with location coordinates and/or orientation.

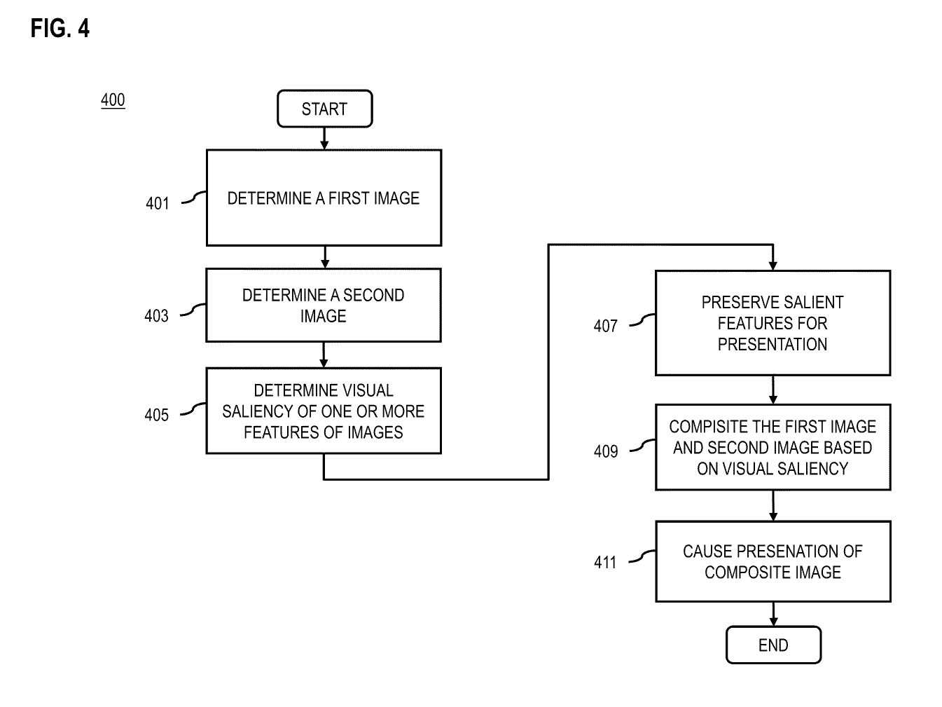

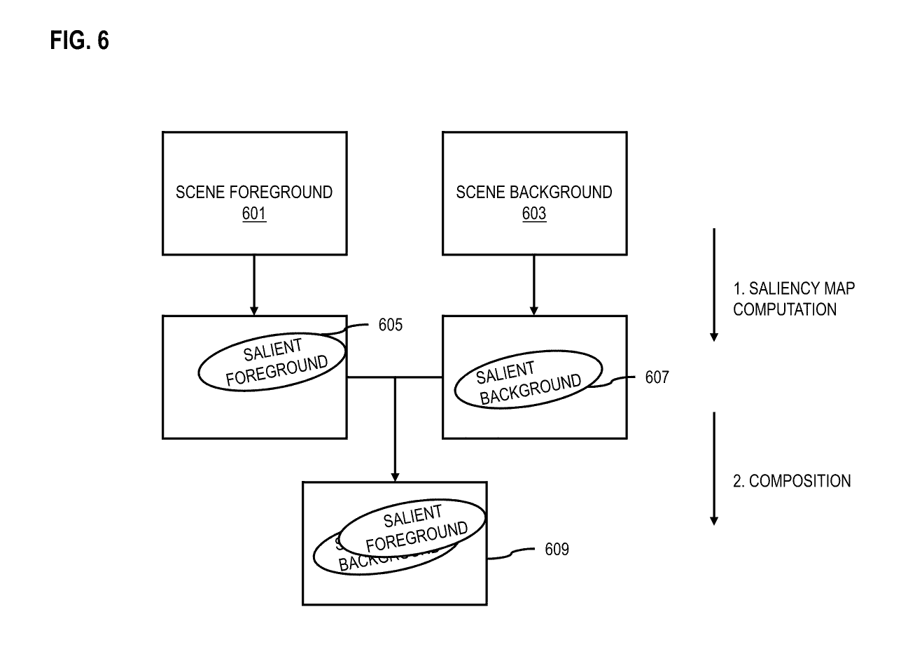

The image capture module 207 can be connected to one or more media capture devices. The image capture module 207 can include optical sensors and circuitry that can convert optical images into a digital format. Examples of image capture modules 207 include cameras, camcorders, etc. The image capture module 207 can process incoming data from the media capture devices. For example, the image capture module 207 can receive a video feed of information relating to a real world environment (e.g., while executing the AR application 109 via the runtime module 209). The image capture module 207 can capture one or more images from the information and/or sets of images (e.g., video). These images may be processed by the image processing module 215 in combination with one or more images of occluded objects as further detailed in FIGS. 4 and 6. The image processing module 215 may be implemented via one or more processors, graphics processors, etc. In certain embodiments, the image capture module 207 can be a means for determining one or more images.

The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, a microphone, etc. Moreover, the user interface 211 may be used to display maps, navigation information, camera images and streams, augmented reality application information, POIs, etc. from the memory 217 and/or received over the communication interface 213. Input can be via one or more methods such as voice input, textual input, typed input, typed touch-screen input, other touch-enabled input, etc. Further, the user interface 211 can additionally be used to retrieve selection information from the user to select one or more objects and/or images associated with an AR X-Ray composite image. Moreover, the user interface 211 can be utilized in causing presentation of images such as the AR X-Ray composite image, an image of a real world environment (e.g., a camera image), a selected image occluded by the real world environment, or a combination thereof. Further, in certain embodiments, the user may capture an image of the real world environment and cause sending of the image with location and/or orientation information to the augmented reality platform 103 to cause storage of the image in the world data 107. Any suitable gear (e.g., a mobile device, augment reality glasses, projectors, a HUD, etc.) can be used as the user interface 211. The user interface 211 may be considered a means for displaying and/or receiving input to communicate information associated with an AR application 109.

FIG. 3A is a diagram showing a map showing an orientation of a UE 101 compared to images stored in a database, according to one embodiment. In this scenario, the UE 101 can be pointed towards a mall 301. Location information can be used to determine the location of the UE 101. Further, orientation information can be utilized to determine the direction 303 the UE 101 is facing. The direction can be based on a reference point (e.g., based on a viewfinder or camera optics) on the UE 101. The AR application 109 of the UE 101 can be utilized to request an image of one or more objects 305, 307, 309 obstructed by the mall 301 from the augmented reality platform 103. For example, these images can be a part of world data 107 that may include one or more images and associated location coordinates and/or orientation of the images. These images can be used to generate the database. In one example, a commercial entity can populate the world data 107 by traversing one or more streets 311, 313, 315 and collecting images with associated location coordinates and/or orientation information. Further, the images can be overlapping to create a panorama of the images. In one embodiment, a distance from the UE 101 can be used to select which image associated with one or more objects 301, 305, 307, and 309 to view. The object can be selected based on a selection parameter, such as distance and/or a level parameter. A level parameter can be the number of images stored in the world data 107 between the object and the UE 101. For example, the mall 301 can be a first level, a lighthouse 305 can be a second level, and the monument 309 can be a third level. These levels may be selected in the AR application 109 via a zoom feature. For example, the zoom feature can be utilized to select how far or which level to utilize in retrieval of the image. Then, the image can be processed in association with another image as an AR X-Ray composite.

Moreover, while presenting the composite image, metadata (e.g., location coordinates, distance to background image, etc.) can be displayed on the UE 101. The metadata may additionally include a status of the image. Further, the status can represent one or more options available to activate with the image. The options may include showing a visual cue that a panorama view of the background image is available. Additionally, the user can select the background image to bring to the foreground (e.g., via a single touch on a touch enabled UE 101).

In certain embodiments, the one or more images or metadata may be provided by one or more peer devices or other remote image-capable devices. For example, the UE 101 may capture an image a building as a foreground image and then retrieve interior images of the same building from peer devices within the building as background images for compositing according to the approach described herein. These peer devices may include one or more UEs 101 associated with one or more other users.

FIGS. 3B-3E are diagrams showing user interfaces to view an augmented reality application, according to various embodiments. As shown in FIG. 3B, a user interface 320 of the AR application 109 can be directed towards a mall 321. Further, the user interface 320 can show guidance as to orientation 323 of the UE 101. Moreover, the user is able to select a layer of AR that the user wishes to view with a layer selection user interface element 325.

In FIG. 3C, the user interface 330 shows a first layer selected 331 on the layer selection user interface element 325. With this layer, a virtual X-Ray view of the mall 321 is performed to show the first layer including a lighthouse 333. This virtual X-Ray view can be based on the saliency of the mall 321 and the lighthouse 333.

FIG. 3D shows a user interface 340 showing a second layer selected 341 on the layer selection user interface element 325. With this layer, a virtual X-Ray view of the mall 321 is performed to show the second layer including a car 343. This virtual X-Ray view can be selected by the user by manipulating the layer selection user interface element 325 (e.g., via user input). Once again, the virtual X-Ray view can be based on the saliency of the mall 321 and the car 343.

FIG. 3E displays another user interface 350 with a first layer selected 351 on the layer selection user interface element 325. With this layer, the virtual X-Ray view of the mall 321 is augmented based on the orientation 353 of the UE 101. In this manner, a tower object 355 is shown in the augmented reality view. The selection to view the tower object 355 can be via the orientation of the UE 101.

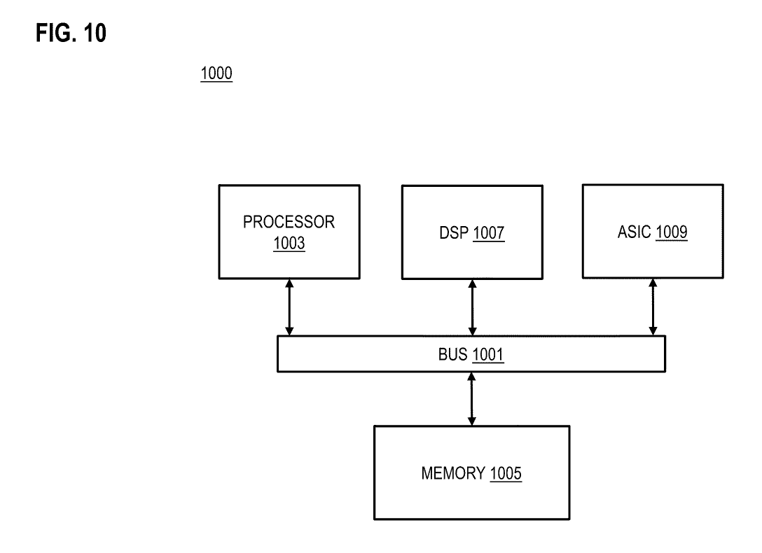

FIG. 4 is a flowchart of a process for providing augmented reality X-Ray images to users, according to one embodiment. In one embodiment, an AR application 109 executing on a runtime module 209 of the UE 101 performs the process 400 and is implemented in, for instance, a chip set including a processor and a memory as shown in FIG. 10. As such, the AR application 109 and/or the runtime module 209 can provide means for accomplishing various parts of the process 400 as well as means for accomplishing other processes in conjunction with other components of the UE 101 and/or augmented reality platform 103.

At step 401, the AR application 109 determines a first image. The first image can be based on a location and/or orientation of the UE 101 and retrieved from world data 107 of an augmented reality platform 103 or be based on an input capture device such as a digital camera. It is contemplated that the input capture device may be a module of the UE 101, a peripheral of the UE 101, associated with other UEs 101, provided by external services, and the like. In this example, one or more portions of the first image can occlude other objects behind the image.

Then, at step 403, the AR application 109 determines a second image. Once again, this can be based on a location of the UE 101. To retrieve one of the images (e.g., the first image or the second image) from the augmented reality platform 103, the AR application 109 causes, at least in part, transmission of a request for the image based, at least in part, on the location of the UE 101. This request can further specify the orientation of the UE 101 and/or a selection parameter (e.g., a distance, level selection parameter, etc.). The augmented reality platform 103 can then process the request and return the appropriate image. Then, the AR application 109 receives the respective image from the augmented reality platform 103.

Further, in certain embodiments, one or more of the images can be requested and received from another UE 101. The other UE 101 may be part of a network service wherein as the other UE 101 captures an image stream and is associated with a location (e.g., by adding location metadata to the stream). The location may be utilized in searching for the other UE 101, which allows for the image stream (or a single image) to be requested and received at the UE 101. This other UE 101 can be associated with another user (e.g., another user of the network service).

Next, at step 405, the AR application 109 determines a visual saliency of one or more features of the first image, the second image, or a combination thereof. The one or more features of the first image can occlude, at least in part, one or more features of the second image. The determination of the visual saliency can be based on a saliency map as detailed in FIG. 5. Moreover, the AR application 109 generates a first saliency map of the respective one or more features of the first image and a second saliency map of the respective features of the second image. The saliency can be based on one or more saliency criteria. For example, saliency criteria can be based on a color hue, a shape, a color intensity, a motion, a luminosity, an intensity, a density, a contrast, a line orientation, a line width, a closure, a lighting direction, a size, a curvature, a three-dimensional depth cue, or a combination thereof. The criteria can be offered to the user as a setting, can be default for the user, etc. A subset of the criteria can be utilized to generate the saliency maps and the criteria may be weighted.

The AR application 109 then determines to preserve salient features for presentation (step 407). In one embodiment, if there is a salient feature on the first image and no conflicting salient feature on the second image, the salient feature of the first image is made opaque or substantially opaque. In another embodiment, if there is a salient feature on the second image and no conflicting salient feature on the first image, the salient feature of the second image is presented while the corresponding area of the first image is made transparent or substantially transparent. A salient feature of the first image conflicts with a salient feature of the second image if overlapping sections of each image include a salient feature.

In one embodiment, the determination of which salient features to present includes determining one or more locations on the first image and the second image where one or more features of the first image occlude, at least in part, one or more features of the second image. For each of the locations a determination is made to determine which of the respective one or more features of the first image or the second image to preserve during a compositing process of step 409 based, at least in part, on one or more criteria.

In this embodiment, the one or more criteria can include a criterion that salient features of a foreground image (e.g., the first image) are preserved during an overlap with salient features of a background image (e.g., the second image). This allows for the user to be able to perceive depth between the foreground and background images.

In another embodiment, an option is provided to the user to change the criterion in a manner such that the user can choose to preserve salient features of the background image and render the salient feature in the foreground image that conflict with the salient features of the background image as transparent or substantially transparent.

In this scenario, preserving the respective one or more features can include rendering of the respective one or more features as opaque or substantially opaque. Further, not preserving the respective one or more features can include causing rendering of the respective one or more features as transparent or substantially transparent.

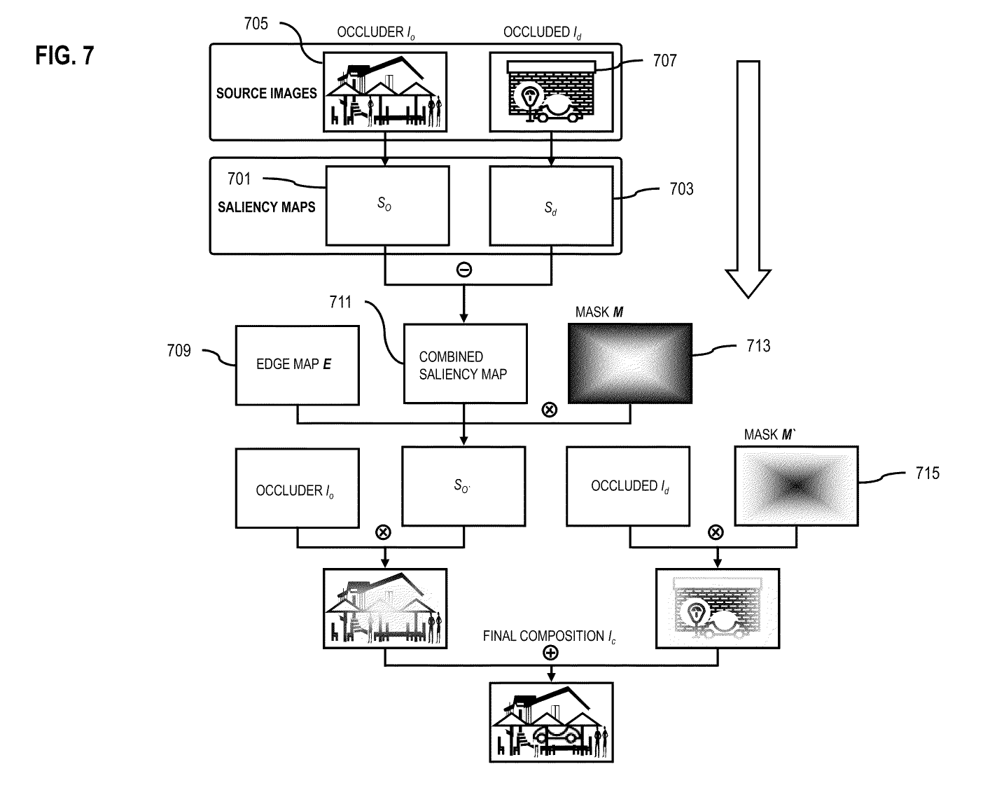

Then, at step 409, the first image and the second image are caused, at least in part, to be composited based, at least in part, on the visual saliency. As previously noted, the compositing can take into account the determination of the salient features and the criteria determining whether to preserve the salient features. Moreover, the compositing can be based on one or more saliency maps and/or edge maps of the first image and/or the second image as further detailed in FIG. 7. Further, the compositing process can additionally include using a mask to create the perception of a virtual or pseudo X-Ray image to users. The mask can be used to create an area where salient features of the background image can be presented on the foreground image.

A presentation of the composite image is caused, at least in part, to be presented via a user interface 211 of the UE 101. Further, the process 400 can be continuously and/or periodically used on one or more foreground and/or background images. In this manner, the user can shift focus of the UE 101 to other locations and/or shift orientation (e.g., by turning or tilting the UE 101). As the UE 101 is moved, the AR X-Ray composite image can be updated via the process 400. Additionally or alternatively, the user can select different layers of second (e.g., background) images.

Further, in certain embodiments, the process 400 can be augmented to include a third image. In this scenario, the third image can be a background image, a foreground image, or in between the first image and the second image. In the latter scenario, one or more features of the third image can occlude one or more features of the second image and be occluded by one or more features of the first image. Criteria can once again be used to determine which salient features to present. In this scenario, the criteria can, in certain embodiments, include that features of the first image are preserved in a conflict with both the second and third image features and the features of the third image (in between the first and second image) are preserved in the case of conflicting features of the second image. Moreover, a touch enabled feature can be provided on the user interface 211 to show parts or all of one of the background images when a salient feature of the background image is selected. It is contemplated that there may be any number of overlapping images with different levels of transparency among the features of the images.

FIG. 5 is a diagram showing different types of saliency maps that can be created based on an input image, according to one embodiment. The figure shows a visual saliency model. An input image 501 can be split into feature maps 503, 505, 507, 509. Features can include luminosity, red/green opponency, blue/yellow opponency, motion, etc. One or more saliency computational models may be used. Each of these feature maps 503, 505, 507, 509 can be used as representations of visual saliency based on different criteria (e.g., red/green, luminosity, etc.).

Sensory properties of the human eye can be modeled to form a hierarchy of receptive cells that respond to contrast between different levels to identify locations that stand out (e.g., that are salient) from the cell's respective surroundings. In one example embodiment, a hierarchy is modeled by sub-sampling an input image 501 I into a dyadic pyramid of σ=[0 . . . 8], such that the resolution of level σ is ½^{σ} the resolution of the original image. It is understood that the value of σ can be variable and dependent on one or more models used in determining the visual saliency. In one embodiment, the image pyramid, P_{σ}, can be utilized to extract visual features based on luminosity i, color hue opponency c, motion t, etc. In one example, luminosity is the brightness of the color component, and a luminosity map can be defined as Mₗ=r+g+b/3. Further, in another example, color hue opponency mimics visual perception's ability to distinguish opposing color hues, for example red-green, blue-yellow, etc. Exemplary red-green and blue yellow opponency maps can be defined respectively as M_{rg}=r−g/max (r, g, b) and M_{by}=b−min(r, g)/max (r, g, b). Further, a single opponency map M_{c} can be generated by combining M_{rg} and M_{by}. Motion can be defined as an observed movement in the luminosity channel over time and can be determined based on more than one image.

Contrasts in the dyadic feature pyramids can be modeled as across scale subtraction between fine and coarse scaled levels of the pyramid. In one example, each of the features, a set of feature maps are generated as: F_{l, c, s}=P_{c} across scale subtraction Pₛ, where/represents the visual feature/includes {l, c, m} includes {2, 3, 4}, s=c+S, and S includes {3, 4}. Feature maps are then combined using an across scale addition to yield one or more conspicuity maps. Then, the conspicuity maps can be combined to form the saliency map 511. A saliency map generated for an image can use one or more criteria (e.g., luminosity, opponency, motion, etc.). Saliency maps of images can be used to identify features for composition as detailed in FIGS. 4, 6, and 7.

FIG. 6 is a diagram depicting composition of two images to generate an augmented reality AR X-Ray composite image, according to one embodiment. A foreground image 601 and a background image 603 are determined at a UE 101. Then, the foreground image is processed to determine a saliency map to determine one or more areas 605 of salient features of the foreground image 601. Additionally, the background image is processed to determine a saliency map to determine one or more areas 607 of salient features of the background image. The foreground image 601 and the background image are then composited based, at least in part, on the salient foreground areas 605 and the salient background areas 607. The composited image 609 can be based on one or more composition criteria for preserving features of the foreground image 601 and the background image 603. In this embodiment, salient feature areas of the foreground image trump the salient feature areas of the background image. In this manner, the user is presented with a composite image in which the user can perceive the depth of the foreground and background images. Additionally, in this scenario, the images can be presented in a manner in which the background image portions are presented through a virtual X-Ray of the foreground image portions.

FIG. 7 is a diagram of a process for compositing images to generate an augmented reality X-Ray composite image, according to one embodiment. Saliency maps S₀ 701 and S_{d} 703 are generated for both an occluder image I₀ 705 and an occluded image I_{d} 707 respectively. In certain embodiments, to highlight edges in the occluder image to emphasize structure, an edge map E 709 can be generated from the occluder region and weighted with the occluder saliency map S₀. For example, E can equal γ(I₀)×S₀×ε. In this scenario, γ can be an edge function (e.g., a Sobel edge function) and ε can be a weighting constant. The edge map 709 can be combined with the occluder saliency map as an addition, that is S_{0′}=S₀+E. Further, S_{0′} and S_{d} can be combined to create a combined saliency map 711 in a manner so as to indicate transparencies of the occluder. In one embodiment, the salient locations of the occluder image 705 take precedence over salient regions of the occluded image 707. In other embodiments, other criteria can be utilized in determining which salient feature to preserve. Further, a mask M 713 and an inverse mask M′ 715 or another mask based on the mask can be utilized to reveal only a portion of the occluded region. This may be utilized to create a focused vision effect. In one embodiment, the final composition I_{C}=S_{0′}×M+P₀×M+P_{d}×M′. In certain embodiments, the occluded image I_{d} can be preprocessed via the inverse mask and/or other filters at the augmented reality platform 103 before being sent to the UE 101. In this composition, the P variable stands for a pyramid associated with the occluder image 705 and the occluded image 707 respectively as further described in FIG. 5. Further, the operations detailed can be performed on each pixel of the corresponding images/feature maps (e.g., as if the pixel values were stored in a matrix).

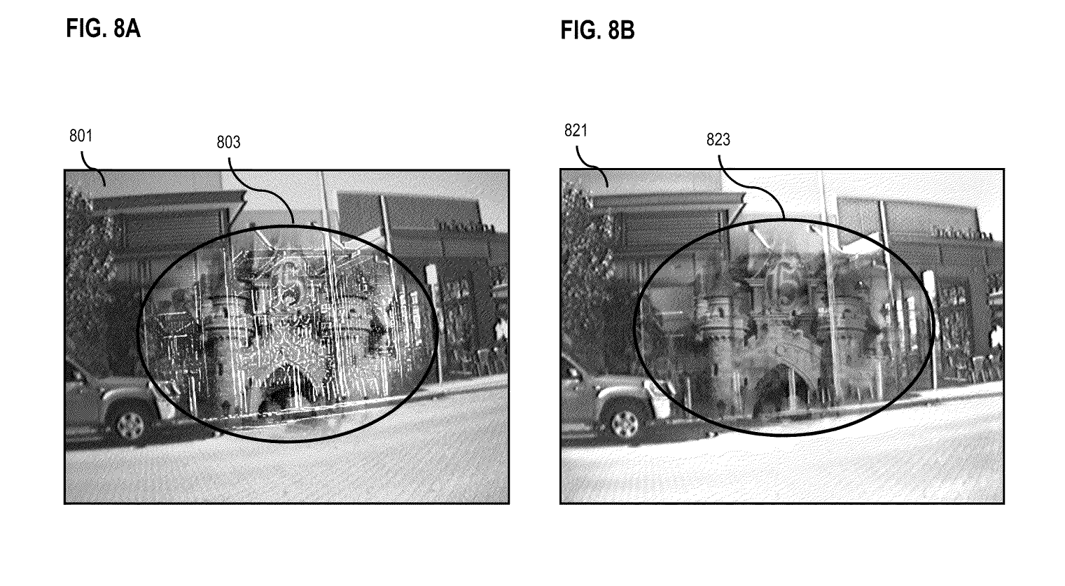

FIGS. 8A and 8B are diagrams of user interfaces showing augmented reality X-Ray images, according to various embodiments. FIG. 8A shows an image of a foreground 801 and an AR X-Ray portion 803 to view a background. In this composite image, certain aspects of the foreground are attempted to be preserved using an edge map. However, the edge map generates noise and it is difficult to determine what features belong to the foreground image and what features belong to the AR X-Ray image. By contrast FIG. 8B includes a foreground 821 and an AR X-Ray portion 823 of a background using the visual saliency approach to determining salient features to preserve of the foreground and background images. As shown, less noise is presented in this scenario while maintaining the salient features of the foreground and background images. Moreover, in certain embodiments, the user may use a touch enabled input (or other input) to select the AR X-Ray portion 823. Upon selection, the background image can be presented full screen, partial screen, unprocessed, or a combination thereof.

With the above approaches, a more visual perceptive augmented reality X-Ray composite image can be generated. By determining salient features of background and foreground images, important features of each image can be maintained to generate perceived depth in the composite image. Further, the above approaches can be performed on a device capturing one of the images to provide rendering in real time. Moreover, the images need not be pre-rendered to provide this real time effect, saving valuable infrastructure time and value.

The processes described herein for providing augmented reality X-Ray images to users may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

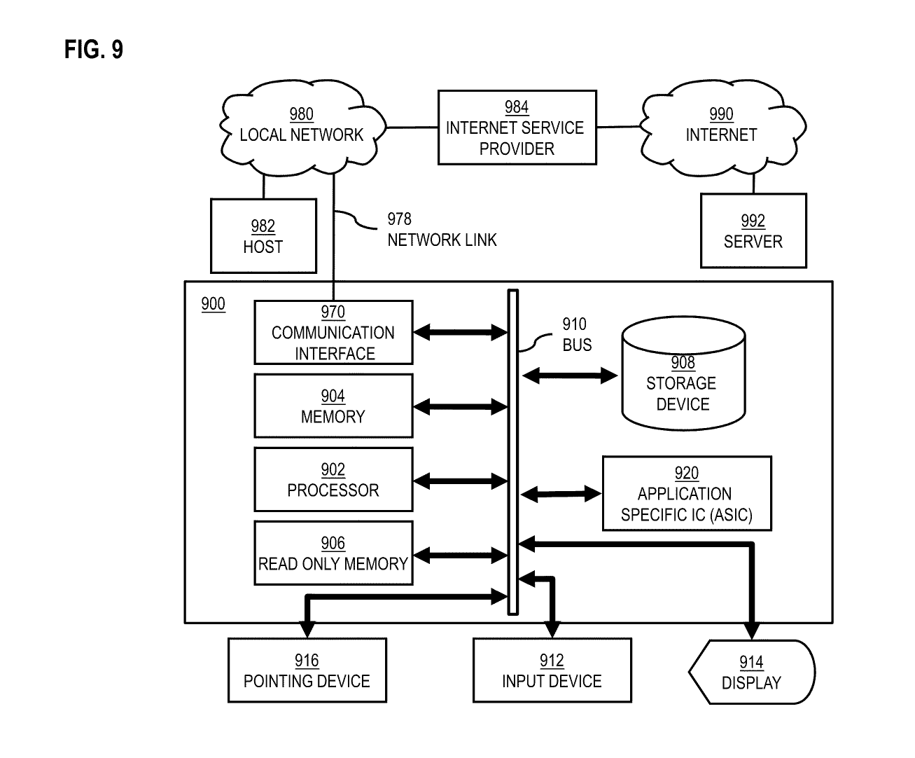

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide augmented reality X-Ray images to users as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing augmented reality X-Ray images to users.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing augmented reality X-Ray images to users. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for providing augmented reality X-Ray images to users. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing augmented reality X-Ray images to users, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for communicating with the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide augmented reality X-Ray images to users as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of services. Chip set or chip 1000, or a portion thereof, constitutes a means for performing one or more steps of providing augmented reality X-Ray images to users.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide augmented reality X-Ray images to users. The memory 1005 also stores the data associated with or generated by the execution of the inventive steps.

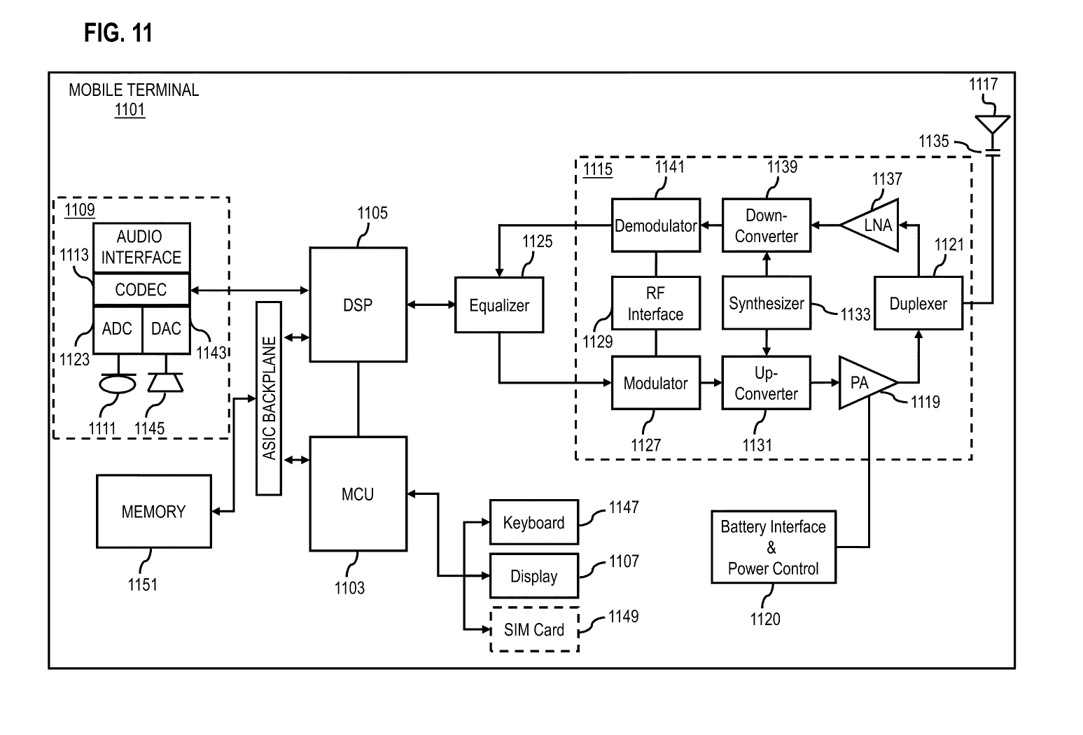

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of providing augmented reality X-Ray images to users. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing augmented reality X-Ray images to users. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide augmented reality X-Ray images to users. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining a visual saliency of one or more features of a first image, a second image, or a combination thereof, wherein the one or more features of the first image occlude, at least in part, one or more features of the second image; and
causing, at least in part, compositing of the first image and the second image based, at least in part, on the visual saliency.

2. A method of claim 1, further comprising:
determining one or more locations in the first image and the second image where the one or more features of the first image occlude, at least in part, the one or more features of the second image; and
for the one or more locations, determining which of the respective one or more features of the first image or the second image to preserve during the compositing based, at least in part, on one or more criteria.

3. A method of claim 2, wherein preserving the respective one or more features comprises causing, at least in part, rendering of the respective one or more features as substantially opaque, and wherein not preserving the respective one or more features comprises causing, at least in part, rendering of the respective one or more features as substantially transparent.

4. A method of claim 1, further comprising:
generating a first saliency map of the respective one or more features of the first image and a second saliency map of the respective one or more features of the second image,
wherein the compositing is further based on the first saliency map, the second saliency map, or a combination thereof.

5. A method of claim 1, further comprising:
generating a edge map of the respective one or more features of the first image,
wherein the compositing is further based on the edge map.

6. A method of claim 1, wherein the visual saliency is determined at a device, the method further comprising:
determining a location of the device;
causing, at least in part, transmission of a request for the second image, based, at least in part, on the location, to a server;
receiving the second image from the server; and
receiving the first image from an image capture device.

7. A method of claim 1, further comprising:
determining a visual saliency of one or more respective features of a third image; and
causing, at least in part, compositing of the third image with the first image and the second image based, at least in part, on the visual saliency of the third image.

8. A method of claim 1, wherein the visual saliency is based, at least in part, on a color hue, a shape, a intensity, a motion, a luminosity, density, size, curvature, three dimensional depth cues, or a combination thereof.

9. An apparatus comprising:
at least one processor; and
at least one memory including computer program code for one or more programs,
the at least one memory and the computer program code configured to, with the at least one processor, cause the apparatus to perform at least the following,
determine a visual saliency of one or more features of a first image, a second image, or a combination thereof, wherein the one or more features of the first image occlude, at least in part, one or more features of the second image; and
cause, at least in part, compositing of the first image and the second image based, at least in part, on the visual saliency.

10. An apparatus of claim 9, wherein the apparatus is further caused to:
determine one or more locations in the first image and the second image where the one or more features of the first image occlude, at least in part, the one or more features of the second image; and
for the one or more locations, determine which of the respective one or more features of the first image or the second image to preserve during the compositing based, at least in part, on one or more criteria.

11. An apparatus of claim 10, wherein preserving the respective one or more features comprises causing, at least in part, rendering of the respective one or more features as substantially opaque, and wherein not preserving the respective one or more features comprises causing, at least in part, rendering of the respective one or more features as substantially transparent.

12. An apparatus of claim 9, wherein the apparatus is further caused to:
generate a first saliency map of the respective one or more features of the first image and a second saliency map of the respective one or more features of the second image,
wherein the compositing is further based on the first saliency map, the second saliency map, or a combination thereof.

13. An apparatus of claim 9, wherein the apparatus is further caused to:
generate a edge map of the respective one or more features of the first image,
wherein the compositing is further based on the edge map.

14. An apparatus of claim 9, wherein the apparatus is further caused to:
determine a location of the apparatus;
cause, at least in part, transmission of a request for the second image, based, at least in part, on the location, to a server;
receive the second image from the server; and
receive the first image from an image capture device.

15. An apparatus of claim 9, wherein the apparatus is further caused to:
determine a visual saliency of one or more respective features of a third image; and
cause, at least in part, compositing of the third image with the first image and the second image based, at least in part, on the visual saliency of the third image.

16. An apparatus of claim 9, wherein the visual saliency is based, at least in part, on a color hue, a shape, a intensity, a motion, a luminosity, density, size, curvature, three dimensional depth cues, or a combination thereof.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
determining a visual saliency of one or more features of a first image, a second image, or a combination thereof, wherein the one or more features of the first image occlude, at least in part, one or more features of the second image; and
causing, at least in part, compositing of the first image and the second image based, at least in part, on the visual saliency.

19. A computer-readable storage medium of claim 18, wherein the apparatus is caused to further perform:
determining one or more locations in the first image and the second image where the one or more features of the first image occlude, at least in part, the one or more features of the second image; and
for the one or more locations, determining which of the respective one or more features of the first image or the second image to preserve during the compositing based, at least in part, on one or more criteria.

20. A computer-readable storage medium of claim 19, wherein preserving the respective one or more features comprises causing, at least in part, rendering of the respective one or more features as substantially opaque, and wherein not preserving the respective one or more features comprises causing, at least in part, rendering of the respective one or more features as substantially transparent.

21-52. (canceled)
